(19) United States
(12) Patent Application Publication
(10) Pub. No.: US 2026/0006317 A1
(43) Pub. Date: Jan. 1, 2026

(54) DYNAMIC POWER MANAGEMENT FOR PHOTON DETECTORS

(71) Applicants: Idea Sistemas Eletronicôs LTDA S.A., Campinas (BR); Universidade Estadual de Campinas, Campinas (BR)

(72) Inventors: Guilherme PAULINO, Campinas (BR); Marcio Colazza ARGENTATO, Campinas (BR); Lucas Francisco WANNER, Paulínia (BR)

(21) Appl. No.: 18/821,224

(22) Filed: Aug. 30, 2024

Related U.S. Application Data
(60) Provisional application No. 63/665,095, filed on Jun. 27, 2024.

(51) Int. Cl. H04N 23/65; H04N 25/709; H04N 25/766; H04N 25/772; H04N 25/773; H04N 25/78

(52) U.S. Cl. CPC H04N 23/651; H04N 25/709; H04N 25/766; H04N 25/772; H04N 25/773; H04N 25/78

(57) ABSTRACT

A photon detector may include a sensor device and a readout component communicatively connected to the sensor device. The sensor device may include a sensor layer including an array of sensor pixels to generate electrical signals responsive to light radiation incident on the sensor layer, and a detector device connected to the sensor layer. The detector device may include an array of detector elements to convert the electrical signals to digital signals based on photon counting, where each of the detector elements includes an analog stage and a digital stage, and a plurality of digital-to-analog converters (DACs) to output bias signals for the analog stages. The readout component may include a management device to output a set of control signals to the plurality of DACs that may cause modification to one or more of the bias signals to affect a power consumption of the detector device.

### CROSS-REFERENCE TO RELATED APPLICATION

This Patent application claims priority to U.S. Provisional Patent Application No. 63/665,095, filed on Jun. 27, 2024, and entitled “DYNAMIC POWER MANAGEMENT FOR PHOTON-COUNTING DETECTORS.” The disclosure of the prior Application is considered part of and is incorporated by reference into this Patent Application.

### TECHNICAL FIELD

The present disclosure relates generally to photon detectors and to dynamic power management for photon detectors.

### BACKGROUND

A photon detector detects and converts light photons into electrical signals, which can be used to create digital images. One example of a photon detector is an x-ray photon detector. X-ray photon detectors can be classified as indirect conversion detectors and direct conversion detectors. In an indirect conversion detector, x-ray photons first interact with a scintillator layer that absorbs x-ray photons and emits light photons in response. The emitted light photons are then detected and converted into electrical signals by an array of photodetectors. In a direct conversion detector, x-ray photons interacting with a semiconductor layer are directly converted into electrical signals (e.g., without the use of a scintillator). Specifically, x-ray photons interacting with the semiconductor layer cause ionization and generate electron-hole pairs. The electron-hole pairs are collected by an electric field to generate an electrical signal. In general, direct conversion can produce higher-quality x-ray images relative to indirect conversion.

### SUMMARY

A photon detector may include a sensor device. The sensor device may include a sensor layer including an array of sensor pixels to generate electrical signals responsive to light radiation incident on the sensor layer. The sensor device may include a detector device, connected to the sensor layer, including an array of detector elements to convert the electrical signals to digital signals based on photon counting. Each of the detector elements may include an analog stage and a digital stage. The detector device may include a plurality of digital-to-analog converters (DACs) to output bias signals for the analog stage of each of the detector elements. The photon detector may include a readout component, communicatively connected to the sensor device, including a management device to output a set of control signals to the plurality of DACs. The set of control signals may cause modification to one or more of the bias signals to affect a power consumption of the detector device.

An x-ray photon detector may include a sensor device. The sensor device may include a sensor layer including an array of sensor pixels to generate electrical signals responsive to light radiation incident on the sensor layer. The sensor device may include a detector device, connected to the sensor layer, including an array of detector elements to convert the electrical signals to digital signals based on photon counting. Each of the detector elements may include an analog stage and a digital stage. The detector device may include a plurality of DACs to output bias signals for the analog stage of each of the detector elements. The photon detector may include a readout component, communicatively connected to the sensor device, including a management device to output a set of control signals to the plurality of DACs. The set of control signals may cause modification to one or more of the bias signals to implement a power mode, of a plurality of power modes, for the detector device.

A method may include identifying, by a device, a power mode, of a plurality of power modes, that is to be used for a detector device. The detector device may include an array of detector elements to convert electrical signals to digital signals based on photon counting, where each of the detector elements comprises an analog stage and a digital stage, and a plurality of DACs to output bias signals for the analog stage of each of the detector elements. The method may include outputting, by the device, a set of control signals to the plurality of DACs. The set of control signals may cause modification to one or more of the bias signals to implement the power mode for the detector device.

### BRIEF DESCRIPTION OF THE DRAWINGS

FIG. 1 is a diagram of an example photon detector.

FIG. 2 is a diagram of an example detector device.

FIG. 3 is a diagram of an example management device.

FIG. 4 is a flowchart of an example process associated with dynamic power management for photon detectors.

### DETAILED DESCRIPTION

The following detailed description of example implementations refers to the accompanying drawings. The same reference numbers in different drawings may identify the same or similar elements.

As described above, a photon detector (sometimes referred to as a “photon-counting detector”), such as an x-ray photon detector, can be used to detect and measure individual photons. A photon detector may include an optical head with one or more sensors that generate electrical signals in response to photons incident on the sensors. The photon detector may also include circuitry to read data out from the sensors and to transmit the data to a computing device for creation of a digital image. For example, an x-ray photon detector can be used to generate digital x-ray images.

Photon detectors can be used in various applications, such as particle accelerator applications (e.g., synchrotrons), materials analysis applications, industrial applications, and medical imaging applications. In some applications, photon detectors may consume excessive power, thereby resulting in increased thermal output. Overheating of photon detectors can result in damage and/or can detrimentally impact detector performance and reliability. To counteract thermal effects, robust cooling systems may be used with photon detectors, thereby increasing complexity, operational costs, and the possibility of component failure.

Implementations described herein relate to power conservation operations for photon detectors. The power conservation operations may reduce a power consumption of a sensor device of a photon detector. As described herein, the sensor device may include a sensor layer and one or more detector devices connected to the sensor layer. A detector device may include an array of detector elements, or “detector pixels,” that are configured to convert electrical signals produced by the sensor layer to digital signals based on photon counting. Each detector element may include an analog stage and a digital stage. The detector device may include a plurality of digital-to-analog converters (DACs) connected to the analog stage of each detector element. The DACs may be configured to output bias signals (e.g., bias voltages and/or bias currents) for the analog stage of each detector element.

The power conservation operations may be performed by a management device of a readout component that is communicatively connected to the sensor device. In one power conservation operation, the management device may use a plurality of power modes to modify a power consumption of the detector device. Each power mode may be implemented by a respective set of control signals for the DACs. For example, each set of control signals may provide a different configuration for the bias signals output by the DACs, thereby affecting a power consumption of the detector device through modification of the bias signals. Thus, to cause the detector device to operate in a particular power mode, the management device may output a particular set of control signals to the DACs, and the set of control signals may cause modification to one or more of the bias signals output by the DACs to thereby affect a power consumption of the detector device. Controlling the bias signals output by the DACs enables fast switching between different power modes. Moreover, through control of the bias signals, the power consumption of the detector device can be manipulated without powering off the detector device or the photon detector. Accordingly, the particular calibration for the detector device provided by the bias signals is not lost, which otherwise would occur if the detector device is powered off.

In another power conservation operation, the management device may disable (e.g., set to zero) one or more cascode bias signals of the DACs to cause the detector device to enter a sleep mode. While the cascode bias signals are disabled, the remaining bias signals may remain enabled (e.g., at their current levels prior to the sleep mode). In this way, the detector device can be put into a sleep mode without powering off the detector device or the photon detector. Accordingly, the particular calibration for the detector device provided by the bias signals is not lost, which otherwise would occur if the detector device is powered off. Furthermore, using the cascode bias signals allows for fast switching between the sleep mode and an awake mode, whereas cycling the power to the detector device or the photon detector is a slow process that increases downtime.

In another power conservation operation, the management device may adjust a frequency of a clock signal input to the detector device (e.g., frequency scaling). The management device may adjust the frequency of the clock signal in accordance with a type of communication that is ongoing or commencing between the management device and the detector device. For example, for control or configuration communication, the clock signal may use a lower frequency, and for pixel readout communication, the clock signal may use a higher frequency. By dynamically lowering the frequency of the clock signal for particular communications, a power consumption of the detector device is reduced.

In another power conservation operation, the management device may adjust a voltage of a power input to the detector device (e.g., power scaling) in accordance with current workload requirements of the detector device. For example, the management device may adjust the voltage of the power input to achieve a particular power consumption or optical performance. By dynamically adjusting the voltage of the power input to the detector device, a power consumption of the detector device is reduced.

In another power conservation operation, the management device may disable the clock signal for the detector device (e.g., clock gating). For example, the management device may disable the clock signal for the detector device during a time period in which communication is absent between the management device and the detector device. By disabling the clock signal, a power consumption of the detector device is reduced.

In another power conservation operation, the management device may disable a power input to the detector device (e.g., power gating). For example, the management device may disable the power input to the detector device responsive to detection of a shutdown condition for the detector device (e.g., an overheating condition). Disabling the power input provides an interlock protection system that can be used to shut down the detector device when a damaging condition (e.g., overheating) is present.

The power conservation operations enhance power efficiency by reducing power usage when detector demand is low, and by scaling up power during peak demand to improve performance. This dynamic approach optimizes power usage, extends a useful life of the photon detector, and improves imaging quality. Moreover, reducing the power consumption of the detector device helps to maintain thermal stability and prolong device longevity. Furthermore, lowering power consumption reduces the risk of overheating and associated failures, thereby enhancing the overall reliability of the photon detector, particularly in a high-demand operational environment. In addition, improving power efficiency reduces the impact of thermal noise for low-intensity measurements and increases the tolerance for radiation damage in high-intensity environments.

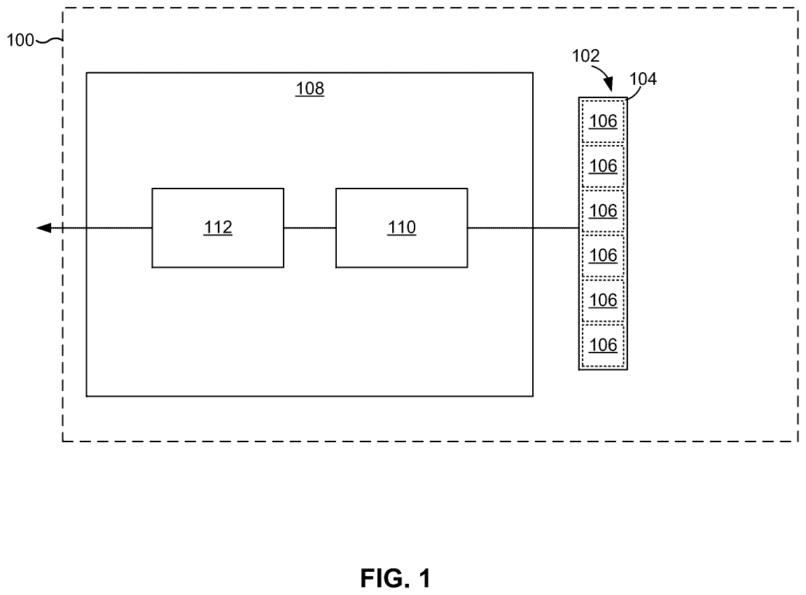

FIG. 1 is a diagram of an example photon detector 100. For example, the photon detector 100 may be an x-ray photon detector configured to detect photons at x-ray wavelengths. Additionally, or alternatively, the photon detector 100 may be configured to detect photons at other wavelengths, such as visible light wavelengths or infrared light wavelengths, among other examples.

The photon detector 100 includes a sensor device 102, which may be referred to as a “detector head” or a “front end” of the photon detector 100. The sensor device 102 may be configured to provide x-ray direct conversion. The sensor device 102 may convert light (e.g., x-ray) photons into electrical signals. In other words, the sensor device 102 may be configured to provide analog to digital conversion of light (e.g., x-ray) signals. The sensor device 102 may include a sensor layer 104 and one or more detector devices 106 connected to the sensor layer 104. In some implementations, the photon detector 100 may include multiple sensor devices 102 (e.g., to achieve a particular-sized detection area).

The sensor layer 104 may include an array of sensor pixels configured to generate electrical signals responsive to light (e.g., x-ray) radiation incident on the sensor layer 104. For example, light (e.g., x-ray) photons interacting with the sensor layer 104 may generate electron-hole pairs representing electrical signals. The sensor layer 104 may include a semiconductor material, such as silicon, gallium arsenide, germanium, amorphous selenium, or cadmium telluride. The sensor layer 104 may include a continuous sheet that includes the array of sensor pixels, or multiple discrete sheets placed side-by-side that in combination provide the array of sensor pixels.

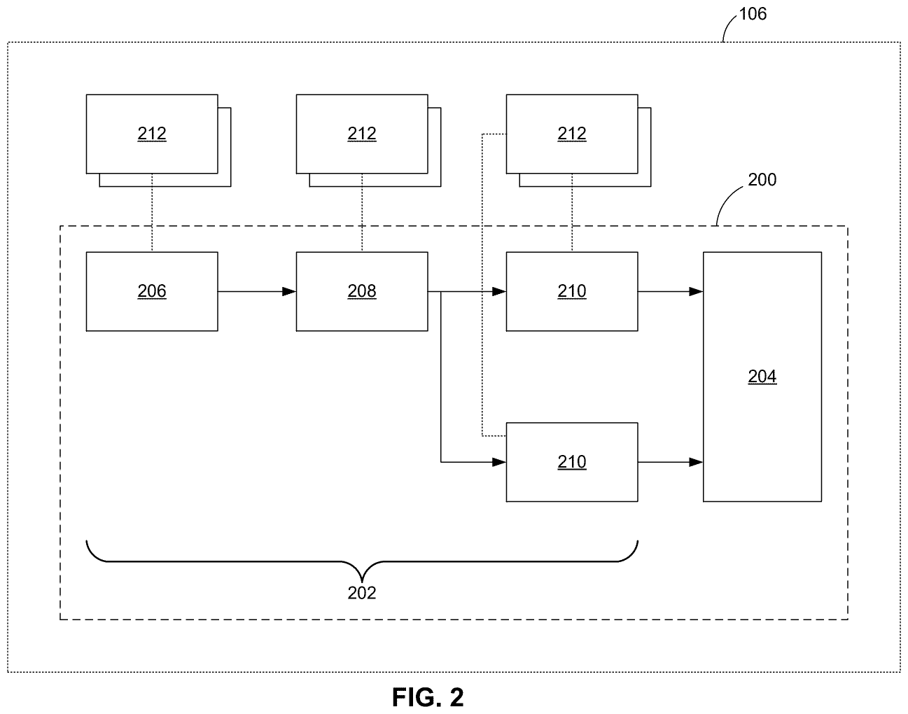

The detector device 106 may include an array of detector elements, or “detector pixels,” that are configured to convert the electrical signals of the sensor layer 104 to digital signals based on photon counting. For example, the photon counting may include incrementing a photon counter if a photon satisfies an energy discrimination level (e.g., thereby filtering out signals, such as background noise, that do not meet particular energy criteria). Accordingly, a detector element may include circuitry configured for photon counting, as described in connection with FIG. 2. The detector device 106 may include an application specific integrated circuit (ASIC) or other circuitry configured to perform the functions of a detector device 106 described herein.

Each of the detector elements of the detector device 106 may correspond to a respective sensor pixel of the sensor layer 104 to provide analog to digital conversion for that pixel (e.g., by photon counting). The sensor device 102 may define a single sensor or multiple sensors, depending on the quantity of detector devices 106 connected to the sensor layer 104 (e.g., a position of a detector device 106 with respect to the sensor layer 104 may define a location of a sensor). For example, the sensor device 102 may define from one to six sensors.

The photon detector 100 includes a readout component 108 communicatively connected to the sensor device 102 (e.g., to enable the exchange of information between the sensor device 102 and the readout component 108). The readout component 108 may include a circuit board (e.g., a printed circuit board (PCB)) that is communicatively connected to the sensor device 102 via an interface (e.g., a high-density interconnection). The readout component 108 may include a management device 110 and a transceiver 112 communicatively connected to the management device 110 (e.g., to enable the exchange of information between the management device 110 and the transceiver 112). The management device 110 may be configured to receive and convert the digital signals (e.g., the data) output by the sensor device 102 into formatted data. For example, the management device 110 may encapsulate data based on the digital signals in accordance with a particular protocol so that the data can be used by the transceiver 112. Additionally, the management device 110 may provide control data to the detector device 106. The management device 110 may be a field programmable gate array (FPGA) or other circuitry configured to perform the functions of a management device 110 described herein.

The transceiver 112 may be configured to transmit (e.g., out from the readout component 108) the formatted data output by the management device 110. The transceiver 112 may have a small form factor pluggable (SFP) form factor. The transceiver 112 may be configured for data transmission and reception over a network, such as an Ethernet network. The transceiver 112 may be an optical transceiver or an electrical transceiver and may be wired or wireless.

In some implementations, the photon detector 100 includes a management component (not shown) communicatively connected to one or more readout components 108. The management component may be configured to provide power and control signals (e.g., for coordination and for configuring a frame rate, an acquire time, a trigger mode, an operational mode, or the like) to a readout component 108. For example, the management component may include a controller (e.g., a microcontroller) configured to provide power and control management for a readout component 108.

As indicated above, FIG. 1 is provided as an example. Other examples may differ from what is described with regard to FIG. 1.

FIG. 2 is a diagram of an example detector device 106. As described herein, the detector device 106 includes an array of detector elements 200 (a single detector element 200 is shown in FIG. 2). For example, the detector device 106 may include a 256×256 matrix of detector elements 200, and each detector element 200 may be 55 micrometers (μm)×55 μm. As shown, the detector element 200 may include an analog stage 202 and a digital stage 204. The analog stage 202 may include a preamplifier stage 206 (e.g., including a charge-summing amplifier), a shaper stage 208 (e.g., including a shaping amplifier), and/or a discriminator (or a comparator) stage 210 (e.g., including one or more discriminator amplifiers), among other examples. The preamplifier stage 206, the shaper stage 208, and/or the discriminator stage 210 may be respective circuits of the analog stage 202. The digital stage 204 may include pulse processing circuitry (e.g., including counter circuitry).

The detector device 106 may further include a plurality of digital-to-analog converters (DACs) 212 connected to the analog stage 202 of each detector element 200. The DACs 212 may be configured to output bias signals (e.g., bias voltages and/or bias currents) for the analog stage 202 of each detector element 200 (e.g., a single set of DACs 212 of the detector device 106 may provide the bias signals for all of the detector elements 200 of the detector device 106). The bias signals are used as reference for biasing the circuits of the analog stage 202. Accordingly, the bias signals can be manipulated to affect a performance and a quality (e.g., in terms of noise) of the imaging of the detector device 106, thereby affecting a power consumption of the detector device 106. For example, biasing of the preamplifier stage 206 may affect noise, gain, and/or speed, and biasing of the shaper stage 208 may affect signal-to-noise ratio (SNR) and/or timing. Moreover, the bias signals provide a particular calibration for the detector device 106, which may be lost when power to the detector device 106 is cycled.

The DACs 212 may include a DAC 212 to output a preamplifier bias signal (e.g., a bias current) for the preamplifier stage 206, a DAC 212 to output a leakage current compensation signal (e.g., a leakage current compensation current) for the preamplifier stage 206, a DAC 212 to output a feedback bias signal (e.g., a bias voltage) for the preamplifier stage 206, a DAC 212 to output a ground bias signal (e.g., a bias voltage) for the preamplifier stage 206, one or more DACs 212 (e.g., a first DAC 212 for the preamplifier stage 206 and a second DAC 212 for the shaper stage 208) to output cascode bias signals (e.g., bias voltages), a DAC 212 to output a shaper bias signal (e.g., a bias current) for the shaper stage 208, a DAC 212 to output a pole-zero bias signal (e.g., a bias voltage) for the shaper stage 208, a DAC 212 to output a discriminator low threshold bias signal (e.g., a bias current) for the discriminator stage 210, and/or a DAC 212 to output discriminator high threshold bias signal (e.g., a bias current) for the discriminator stage 210, among other examples.

As indicated above, FIG. 2 is provided as an example. Other examples may differ from what is described with regard to FIG. 2.

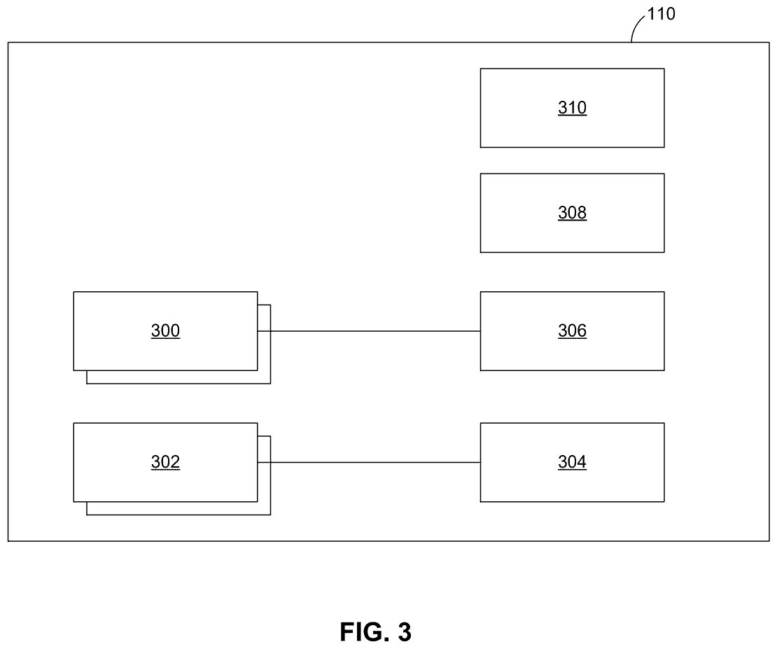

FIG. 3 is a diagram of an example management device 110. The management device 110 may include one or more clock sources 300 that generate clock signals for the detector device 106. For example, the management device 110 may include multiple clock sources 300 that output clock signals at different frequencies (e.g., 40 megahertz (MHz), 200 MHz, and 315 MHz), or may include a single clock source 300 that outputs a clock signal that can be adjusted in frequency. In addition, the management device 110 may include one or more power supplies 302 that power the detector device 106. For example, the management device 110 may include multiple power supplies 302, including a primary power supply (e.g., at 1.5 volts), a digital circuitry power supply (e.g., at 2.5 volts), and an analog circuitry power supply (e.g., at 1.5 volts), among other examples.

In some implementations, the management device 110 includes multiple components (e.g., implemented in circuitry) that are used to perform power conservation operations described herein. For example, the management device 110 may include a power management component 304, a clock management component 306, a sleep management component 308, and/or a DAC management component 310. The power management component 304 may provide control over the power supplied to the detector device 106. For example, the power management component 304 may control the power supplies 302. The clock management component 306 may provide control over the clock signal input to the detector device 106. For example, the clock management component 306 may control the clock sources 300. The sleep management component 308 may provide control over a sleep mode for the detector device 106 by controlling a control signal for the one or more DACs 212 that output cascode bias signals. The DAC management component 310 may provide control over a power mode for the detector device 106 by controlling control signals for the DACs 212.

The management device 110 (e.g., using the power management component 304, the clock management component 306, the sleep management component 308, and/or the DAC management component 310) may perform various power conservation operations to reduce a power consumption of the detector device 106. The management device 110 may perform one or more of the various power conservation operations continuously, periodically, responsive to a command (e.g., that is user-initiated), and/or responsive to detection of a condition. In some implementations, the management device 110 may perform multiple power conservation operations concurrently.

In one power conservation operation, the management device 110 may use a plurality of power modes to modify a power consumption of the detector device 106. Each power mode may be implemented by a respective set of control signals for the DACs 212. For example, each set of control signals may provide a different configuration for the bias signals output by the DACs 212, thereby affecting a power consumption of the detector device 106 through modification of the bias signals. Thus, to cause the detector device 106 to operate in a particular power mode, the management device 110 (e.g., using the DAC management component 310) may output a particular set of control signals to the DACs 212, and the set of control signals may cause modification to one or more of the bias signals output by the DACs 212 to thereby affect a power consumption of the detector device 106. As an example, the power modes may include a low power mode, a standard power mode (with higher power consumption than the low power mode), and a high power (or low noise) mode (with higher power consumption than the standard power mode).

In some implementations, the management device 110 may output the set of control signals, for the power mode, to the DACs 212 responsive to a command indicating that the power mode is to be used for the detector device 106. For example, the command may be indicated by a user input made to the photon detector 100. In some implementations, the management device 110 may output the set of control signals, for the power mode, to the DACs 212 responsive to detection of a condition for using the power mode. For example, the condition may be that a temperature of the detector device 106 satisfies (e.g., is greater than, equal to, or less than) a threshold. Here, the detector device 106 may include a temperature sensor, and the detector device 106 may provide sensor feedback to the management device 110. In some implementations, the management device 110 may output the set of control signals, for the power mode, to the DACs 212 at an initialization (e.g., startup) of the detector device 106.

In some implementations, one or more sets of control signals for the DACs 212 may relate to one or more different performance modes for the detector device 106. A performance mode is a closely related concept to a power mode because each performance mode may result in a different power consumption. However, for a performance mode, a set of control signals may provide a configuration for the bias signals output by the DACs 212 that achieves a particular performance objective. As an example, the performance modes may include a high flux mode, a low noise mode (or a high SNR mode), a high contrast mode, a high counting rate linearity mode, or a high energy resolution mode, among other examples.

In another power conservation operation, the management device 110 (e.g., using the sleep management component 308) may disable (e.g., set to zero) the cascode bias signals to cause the detector device 106 to enter a sleep mode. In some implementations, the management device 110 may cause the detector device 106 to enter the sleep mode responsive to detecting an absence of communication, or an end of a communication, between the detector device 106 and the management device 110. Disabling the cascode bias signals may disable the preamplifier stage 206 and/or the shaper stage 208 of the analog stage 202, thereby disabling photon detection operations and conserving power. While the cascode bias signals are disabled, the remaining bias signals may remain enabled (e.g., at their current levels prior to the sleep mode). In this way, the detector device 106 can be put into a sleep mode without powering off the detector device 106 or the photon detector 100. Accordingly, the particular calibration for the detector device 106 provided by the bias signals is not lost, which otherwise would occur if the detector device 106 is powered off. Furthermore, using the cascode bias signals allows for fast switching between the sleep mode and an awake mode, whereas cycling the power to the detector device 106 or the photon detector 100 is a slow process that increases downtime.

In another power conservation operation, the management device 110 (e.g., using the clock management component 306) may adjust (e.g., dynamically) a frequency of a clock signal input to the detector device 106 (e.g., frequency scaling). For example, the management device 110 may select a frequency (e.g., from among multiple options) for the clock signal. The management device 110 may adjust the frequency of the clock signal in accordance with a type of communication that is ongoing or commencing between the detector device 106 and the management device 110. For example, for control or configuration communication, the clock signal may use a lower frequency, and for pixel readout communication, the clock signal may use a higher frequency. By dynamically lowering the frequency of the clock signal for particular communications, a power consumption of the detector device 106 is reduced.

In another power conservation operation, the management device 110 (e.g., using the power management component 304) may adjust (e.g., dynamically) a voltage of a power input to the detector device 106 (e.g., power scaling) in accordance with current workload requirements of the detector device 106 (e.g., so as to coincide with varying operational conditions). For example, the management device 110 may adjust the voltage of the power input to achieve a particular power consumption or optical performance. By dynamically adjusting the voltage of the power input to the detector device 106, a power consumption of the detector device 106 is reduced.

In another power conservation operation, the management device 110 (e.g., using the clock management component 306) may disable the clock signal for the detector device 106 (e.g., clock gating). For example, the management device 110 may disable the clock signal for the detector device 106 during a time period in which communication is absent between the detector device 106 and the management device 110. By disabling the clock signal, a power consumption of the detector device 106 is reduced.

In another power conservation operation, the management device 110 (e.g., using the power management component 304) may disable a power input to the detector device 106 (e.g., power gating). For example, the management device 110 may disable the power input to the detector device 106 responsive to detection of a shutdown condition for the detector device 106. The shutdown condition may be a condition of the detector device 106 that has the potential to cause damage to the detector device 106. For example, the shutdown condition may be that a temperature of the detector device 106 satisfies (e.g., is greater than or equal to) a threshold. Disabling the power input provides an interlock protection system that can be used to shut down the detector device 106 when a damaging condition (e.g., overheating) is present.

As indicated above, FIG. 3 is provided as an example. Other examples may differ from what is described with regard to FIG. 3.

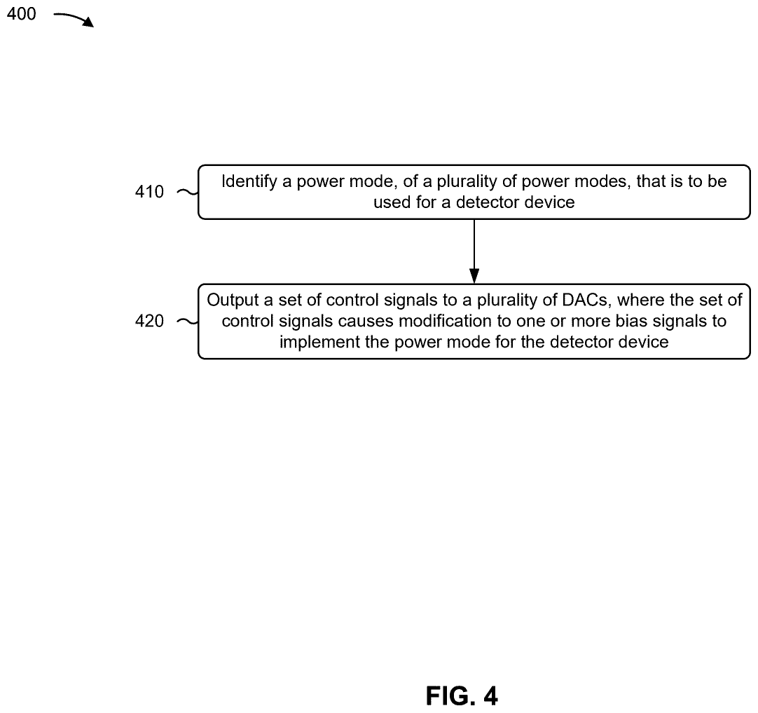

FIG. 4 is a flowchart of an example process 400 associated with dynamic power management for photon detectors. In some implementations, one or more process blocks of FIG. 4 are performed by a management device (e.g., management device 110) and/or a component of a management device (e.g., power management component 304, clock management component 306, sleep management component 308, and/or DAC management component 310). In some implementations, one or more process blocks of FIG. 4 are performed by another device or a group of devices separate from or including the management device, such as a readout component (e.g., readout component 108), a sensor device (e.g., sensor device 102), and/or a detector device (e.g., detector device 106).

As shown in FIG. 4, process 400 may include identifying a power mode, of a plurality of power modes, that is to be used for a detector device (block 410). As described herein, the detector device may include an array of detector elements to convert electrical signals to digital signals based on photon counting, where each of the detector elements includes an analog stage and a digital stage, and a plurality of DACs to output bias signals for the analog stage of each of the detector elements. For example, the management device (e.g., using one or more memories, one or more processors, and/or the DAC management component 310) may identify the power mode, as described above.

As further shown in FIG. 4, process 400 may include outputting a set of control signals to the plurality of DACs, where the set of control signals causes modification to one or more of the bias signals to implement the power mode for the detector device (block 420). For example, the management device (e.g., using one or more memories, one or more processors, an output component, and/or the DAC management component 310) may output the set of control signals, as described above.

Process 400 may include additional implementations, such as any single implementation or any combination of implementations described below and/or in connection with one or more other processes described elsewhere herein.

In some implementations, identifying the power mode includes receiving a command indicating that the power mode is to be used for the detector device. In some implementations, identifying the power mode includes detecting a condition for using the power mode for the detector device. In some implementations, process 400 includes identifying a different power mode, of the plurality of power modes, that is to be used for the detector device, and outputting a different set of control signals to the plurality of DACs, where the different set of control signals causes modification to one or more of the bias signals to implement the different power mode for the detector device.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., an ASIC or one or more ASICs, an FPGA or one or more FPGAs, or the like) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A photon detector, comprising:
a sensor device comprising:
a sensor layer comprising an array of sensor pixels to generate electrical signals responsive to light radiation incident on the sensor layer; and
a detector device, connected to the sensor layer, comprising:
an array of detector elements to convert the electrical signals to digital signals based on photon counting,
wherein each of the detector elements comprises an analog stage and a digital stage; and
a plurality of digital-to-analog converters (DACs) to output bias signals for the analog stage of each of the detector elements; and
a readout component, communicatively connected to the sensor device, comprising a management device to output a set of control signals to the plurality of DACs,
wherein the set of control signals causes modification to one or more of the bias signals to affect a power consumption of the detector device.

2. The photon detector of claim 1, wherein the analog stage comprises a preamplifier stage and a shaper stage.

3. The photon detector of claim 2, wherein the bias signals comprise a preamplifier bias signal for the preamplifier stage, a leakage current compensation signal for the preamplifier stage, a feedback bias signal for the preamplifier stage, a ground bias signal for the preamplifier stage, a cascode bias signal for the preamplifier stage, a cascode bias signal for the shaper stage, and a pole-zero bias signal for the shaper stage.

4. The photon detector of claim 1, wherein the set of control signals implements a power mode, of a plurality of power modes, for the detector device.

5. The photon detector of claim 4, wherein the management device is to output the set of control signals to the plurality of DACs responsive to a command indicating that the power mode is to be used for the detector device.

6. The photon detector of claim 4, wherein the management device is to output the set of control signals to the plurality of DACs responsive to detection of a condition for using the power mode for the detector device.

7. The photon detector of claim 1, wherein the management device is further to:
disable at least one of a cascode bias signal for a preamplifier stage of the analog stage or a cascode bias signal for a shaper stage of the analog stage to cause the detector device to enter a sleep mode.

8. The photon detector of claim 1, wherein the management device is further to:
adjust a frequency of a clock signal input to the detector device in accordance with a type of communication between the management device and the detector device.

9. The photon detector of claim 1, wherein the management device is further to:
adjust a voltage of a power input to the detector device to achieve a particular power consumption or optical performance.

10. The photon detector of claim 1, wherein the management device is further to:
disable a clock signal for the detector device during a time period in which communication is absent between the management device and the detector device.

11. The photon detector of claim 1, wherein the management device is further to:
disable a power input to the detector device responsive to detection of a shutdown condition for the detector device.

12. An x-ray photon detector, comprising:
a sensor device comprising:
a sensor layer comprising an array of sensor pixels to generate electrical signals responsive to light radiation incident on the sensor layer; and
a detector device, connected to the sensor layer, comprising:
an array of detector elements to convert the electrical signals to digital signals based on photon counting,
wherein each of the detector elements comprises an analog stage and a digital stage; and
a plurality of digital-to-analog converters (DACs) to output bias signals for the analog stage of each of the detector elements; and
a readout component, communicatively connected to the sensor device, comprising a management device to output a set of control signals to the plurality of DACs,
wherein the set of control signals causes modification to one or more of the bias signals to implement a power mode, of a plurality of power modes, for the detector device.

13. The x-ray photon detector of claim 12, wherein the set of control signals causes modification to the one or more of the bias signals to affect a power consumption of the detector device.

14. The x-ray photon detector of claim 12, wherein the management device is to output the set of control signals to the plurality of DACs responsive to:
a command indicating that the power mode is to be used for the detector device, or
detection of a condition for using the power mode for the detector device.

15. The x-ray photon detector of claim 12, wherein the management device is further to:
disable at least one of a cascode bias signal for a preamplifier stage of the analog stage or a cascode bias signal for a shaper stage of the analog stage to cause the detector device to enter a sleep mode.

16. The x-ray photon detector of claim 12, wherein the analog stage comprises a charge-summing amplifier and a shaping amplifier.

17. A method, comprising:
identifying, by a device, a power mode, of a plurality of power modes, that is to be used for a detector device, the detector device comprising:
an array of detector elements to convert electrical signals to digital signals based on photon counting,
wherein each of the detector elements comprises an analog stage and a digital stage; and
a plurality of digital-to-analog converters (DACs) to output bias signals for the analog stage of each of the detector elements; and
outputting, by the device, a set of control signals to the plurality of DACs,
wherein the set of control signals causes modification to one or more of the bias signals to implement the power mode for the detector device.

18. The method of claim 17, wherein identifying the power mode comprises:
receiving a command indicating that the power mode is to be used for the detector device.

19. The method of claim 17, wherein identifying the power mode comprises:
detecting a condition for using the power mode for the detector device.

20. The method of claim 17, further comprising:
identifying a different power mode, of the plurality of power modes, that is to be used for the detector device; and
outputting a different set of control signals to the plurality of DACs,
wherein the different set of control signals causes modification to one or more of the bias signals to implement the different power mode for the detector device.
